(19) United States
(12) Patent Application Publication
(10) Pub. No.: US 2011/0110542 A1
(43) Pub. Date: May 12, 2011

(54) PIEZOELECTRIC EXCITER AND PIEZOELECTRIC EXCITER UNIT

(75) Inventor: Mitsuhiro Masuda, Shizuoka (JP)

(73) Assignee: STAR MICRONICS CO., LTD., Shizuoka-shi, Shizuoka (JP)

(21) Appl. No.: 13/002,073

(22) PCT Filed: May 11, 2009
(86) PCT No.: PCT/JP2009/002032

§ 371 Date: Dec. 30, 2010

(30) Foreign Application Priority Data
Jun. 30, 2008 (JP) 2008-170453

(51) Int. Cl. H04R 17/00

(52) U.S. Cl. 381/190

(57) ABSTRACT

A piezoelectric exciter includes: a beam including a substrate and a piezoelectric element affixed to the substrate; a supporting portion that supports the beam; a terminal fixed to the supporting portion, the terminal feeding electricity to the piezoelectric element; and a conductive member that electrically connects the terminal to an electrode of the piezoelectric element, wherein a conductive-member-containing recess is formed in the supporting portion and the conductive member is contained in the conductive-member-containing recess in an embedded state and wherein the supporting portion is made of a resin that is subjected to insert molding together with the substrate and the beam is made by affixing the piezoelectric element to the substrate after the insert molding.

### TECHNICAL FIELD

The present invention relates to a piezoelectric exciter that is suitable for use as a sound/vibration generating device of a panel speaker.

### BACKGROUND ART

Piezoelectric exciters have been developed that include a beam and a supporting portion that supports the beam. The beam includes a substrate made of a metal plate and one or two piezoelectric elements affixed to one side or both sides of the substrate. The supporting portion is made of a resin. The beam warps and vibrates when electricity is supplied to the piezoelectric element(s) (PTL 1). Some types of piezoelectric exciters include a plurality of beams that are disposed parallel to each other with intervals therebetween. The range of applications and functions of such exciters can be expanded by using beams having different characteristics. For example, the exciters may be provided with a wide-band characteristic, or some beams may be used for generating only sound while other beams may be used for generating only vibration. Among such piezoelectric exciters including a plurality of beams, the following types are known: a type in which an end portion of a beam is supported with one supporting portion (PTL 2); a type in which a plurality of beams are contained in one casing and the casing supports an end portion or a middle portion of each beam (PTLs 3 to 5); and a type in which an end portion of a beam is supported by being sandwiched between a plurality of supporting portions (PTL 6).

Electricity is supplied to the piezoelectric element through a conductive member connected to an electrode of the piezoelectric element. As the conductive member, an elastic spring member, such as a U-shaped pin, is sandwiched between the supporting member and the electrode (PTLs 1 to 3).

### Citation List

### Patent Literature

PTL 1: Japanese Unexamined Patent Application Publication No. 2007-019672
PTL 2: Japanese Unexamined Patent Application Publication No. 2006-116399
PTL 3: Japanese Unexamined Patent Application Publication No. 2005-066500
PTL 4: Japanese Unexamined Patent Application Publication No. 2005-160028
PTL 5: Japanese Unexamined Patent Application Publication No. 2007-221313
PTL 6: Japanese Unexamined Patent Application Publication No. 2008-125005

### SUMMARY OF INVENTION

### Technical Problem

An exciter including a plurality of beams has many applications and functions as described above and is therefore promising. However, in order to fulfill the needs for various functions with the exciter described in PTLs 2 to 5, in which one supporting portion supports a plurality of beams, it is necessary to adopt a production system that can design and produce many types of customized exciters. Such a production system has a problem in that the number of production lines is increased, the production management becomes complex, and the cost is increased. In this respect, the exciter described in PTL 6, in which an end portion of a beam is sandwiched between a plurality of beams and supported, an exciter having a desired function can be relatively easily produced by selecting and combining beams having different characteristics. However, the supporting portion and the beams are independent members, so that it takes time and effort to match these members appropriately. Moreover, characteristics of such exciters vary widely because the positions of the beam and the supporting portions may be moved while sandwiching and affixing the beam between the supporting portions.

Therefore, it has been conceived that an exciter including a plurality of beams can be made by stacking exciters, each including a beam integrated with a supporting portion, in such a way that the supporting portions thereof are superposed on each other. In this case, flat surfaces of the supporting portions are joined to each other. If, for example, as with the type described in PTL 1, conductive members for feeding electricity to the piezoelectric elements are spring members protruding from the outer surfaces of the supporting portions, it is necessary to stack the exciters avoiding the areas from which the terminals protrude. However, in this case, the contact area is reduced so that it may become difficult to securely attach the exciters to each other. Moreover, the protrusion of the spring members makes it difficult to reduce the thickness of the exciter. As described in PTL 5, an electrically conductive adhesive can be used for connecting the electrodes of piezoelectric elements to each other. However, in this case, vibration characteristics may vary depending on the amount of the electrically conductive adhesive applied, and dripping of the adhesive may cause a short-circuit.

When using the exciter described in PTL 1 alone (with only one beam) by attaching the exciter to, for example, an apparatus such as a flat panel speaker, a flat surface of the supporting portion of the exciter is affixed to the apparatus. However, the entirety of the flat surface cannot be used because of the interference by the spring member, so that the exciter is not securely fixed. If the exciter is not securely fixed to the apparatus, the exciter may drop off the apparatus, or the performance of the exciter may not be fully utilized.

One of objects of the present invention is to provide a piezoelectric exciter with which a large area of a surface of a supporting portion can be used to attach the exciter to an apparatus without being interfered by a conductive member and the supporting portion can be securely and strongly fixed to the apparatus, and thereby the performance of the piezoelectric exciter can be fully utilized. Another object of the present invention is to provide a piezoelectric exciter unit including a plurality of exciters that are stacked, which can be produced with reduced time and effort, using a simplified production line, and at low-cost while standardizing the product.

### Solution to Problem

According to the embodiment of the present invention, there is provided a piezoelectric exciter including: a beam including a substrate and a piezoelectric element affixed to the substrate; a supporting portion that supports the beam; a terminal fixed to the supporting portion, the terminal feeding electricity to the piezoelectric element; and a conductive member that electrically connects the terminal to an electrode of the piezoelectric element, wherein a conductive-member-containing recess is formed in the supporting portion, and wherein the conductive member is contained in the conductive-member-containing recess in an embedded state.

With the piezoelectric exciter according to the embodiment, the conductive member is contained in the conductive-member-containing recess in an embedded state, the conductive-member-containing recess being formed in the supporting portion. Therefore, the conductive member does not protrude from the outer surface of the supporting portion. By using the outer surface as a flat attachment surface, the effective area of the attachment surface can be increased. As a result, the exciter can be fixed to an apparatus with a sufficient strength, whereby the performance of the exciter can be fully utilized.

In the exciter according to the embodiment, the supporting portion may be made of a resin that is subjected to insert molding together with the substrate, and the beam may be made by affixing the piezoelectric element to the substrate after the insert molding. In this case, molding of the supporting portion and integration of the supporting portion and the substrate can be performed in one step. Therefore, productivity is increased, and the substrate can be securely fixed to the supporting portion. The supporting portion can be positioned relative to the substrate with high precision.

When a resin is heated and melted to perform insert molding, the piezoelectric element has not been affixed to the substrate. Therefore, insert molding can be performed without consideration of the effect of heat. Therefore, the resin used as a material of the supporting portion 30 is not limited to a low-temperature type, and flexibility in the choice of the resin material is increased. Additional effects is obtained in that, for example, the cost can be reduced by using an inexpensive resin, the size and the thickness of the exciter can be reduced by molding a thin member using a high-mobility material.

The conductive member according to the embodiment may be an elastic U-shaped pin. The pin is contained in the conductive-member-containing recess in a state in which the pin elastically contacts a bottom portion of the conductive-member-containing recess. Because the pin occupies a comparatively small space, the size of the conductive-member-containing recess can be reduced accordingly. As a result, reduction in the attachment area of the supporting portion is suppressed, and the strength of fixing can be increased.

In the embodiment, the depth of the conductive-member-containing recess may be set so that a gap is generated between the conductive member and the electrode of the piezoelectric element when the conductive member is contained in the conductive-member-containing recess, and the conductive member and the electrode may be connected to each other with a conductive joint member, such as a conductive adhesive. The size of the gap is preferably smaller than about 0.5 mm. As the conductive joint member, a piece of solder or electrically conductive adhesive is used.

In this case, when assembling the exciter, the conductive member is prevented from contacting the electrode of the piezoelectric element by being stopped by the bottom portion of the conductive-member-containing recess that contains the conductive member, and the gap is generated between the conductive member and the electrode of the piezoelectric element. Because the conductive member does not directly contact the electrode of the piezoelectric element, a stress that acts on an interface between the piezoelectric element and the conductive joint member when the beam vibrates is reduced, whereby malfunctioning is prevented from occurring. Moreover, when assembling the exciter, the conductive member does not contact and damage the electrode of the piezoelectric element, so that the quality of the exciter can be maintained.

According to the embodiment, a piezoelectric exciter unit includes a plurality of the piezoelectric exciters each according to the present invention, the piezoelectric exciters being stacked so that the supporting portions thereof are superposed on each other and joined to each other, wherein a hollow space is formed in the supporting portion of each of the piezoelectric exciters, the hollow space extending, in a stacked state, from the terminal of the piezoelectric exciter to the terminal of the other one of the piezoelectric exciters that is stacked on the piezoelectric exciter, and wherein a terminal conductive member is interposed between the terminals in the hollow spaces that are continuous with each other, the terminal conductive member electrically connecting the terminals to each other.

The piezoelectric exciter unit according to the embodiment includes the exciters, each according to the present invention, that are stacked. As described above, the conductive member of each of the exciters is contained in the conductive-member-containing recess formed in the supporting portion and does not protrude from the outer surface of the supporting portion. Therefore, almost the entire area of the outer surface of the supporting portion of one of the exciters can closely contact the outer surface of the supporting portion of the other one of the exciters to be joined. As a result, the exciters can be strongly and securely joined to each other. It is preferable that the supporting portions be joined to each other by welding the joint surfaces to each other by using ultrasound or the like so as to make a strong joint.

Because the exciter unit 2 is made by stacking the individual exciters 1, each of which has been completed, when there are various needs for functions, the needs can be easily fulfilled by combining the exciters having different characteristics. Therefore, time and effort needed to produce the exciter unit 2 are reduced, the efficiency of the production line can be increased, the product can be standardized, and the cost can be reduced.

Because the terminals of a plurality of exciters are connected to each other with the terminal conductive member, electricity can be fed to all exciters by feeding one of the exciters. Therefore, the lead wires for feeding electricity may be connected to only one of the exciters, whereby the structure can be simplified. Because the terminal conductive member is interposed between the terminals and does not protrude to the outside, the thickness can be reduced.

In the piezoelectric exciter unit according to the embodiment, the terminal conductive member may be an elastic member that elastically contacts the terminals of the exciters. Because the terminal conductive member, which is an elastic member, is interposed between the terminals of the stacked exciters in an elastically deformed state and elastically contacts the terminals, electrical connection between the terminals is reliably maintained.

A cushioning member may be interposed between the beams of the piezoelectric exciters. This is preferable because the intervals between the beams are maintained and contact between the beams is prevented.

### Advantageous Effects of Invention

With the piezoelectric exciter according to the embodiment, a large area of a surface of the supporting portion can be used to attach the piezoelectric exciter to an apparatus without being interfered by a conductive member and the supporting portion can be securely and strongly fixed to the apparatus, and thereby the performance of the piezoelectric exciter is fully utilized.

### DESCRIPTION OF EMBODIMENTS

Hereinafter, an embodiment of the present invention will be described with reference to the drawings.

### [1] Single Exciter

(1-1) Structure

FIGS. 1A-1D illustrate a piezoelectric exciter according to the present invention. The exciter 1 is a single exciter including one beam. In FIGS. 1A-1D, a numeral 10 indicates a substrate made of a rectangular thin metal plate. The substrate 10, which is also called a shim, is made of a metal material, such as a stainless steel or a copper alloy. As illustrated in FIG. 2A, a first terminal 11 is integrally formed at an end of the substrate 10 in the longitudinal direction of the substrate 10. The first terminal 11 is rectangular and protrudes in the longitudinal direction. The first terminal 11 is formed near an end of the substrate 10 in the width direction.

Piezoelectric elements 20, having rectangular shapes, are affixed to both sides of the substrate 10 by means of an electrically conductive adhesive or the like. As illustrated in FIGS. 2A-2C, the piezoelectric elements 20 cover almost the entire area of both sides of the substrate 10 except for a certain region at an end of the substrate 10 in which the first terminal 11 is formed. A beam refers to a member including the substrate 10 and the piezoelectric elements 20 affixed to both sides of the substrate 10. In the present embodiment, a beam 25, which includes the substrate 10 and the piezoelectric elements 20 affixed to both sides of the substrate 10, is of a bimorph type. A beam including a substrate and a piezoelectric element affixed to one side of the substrate is called a monomorph type. The present invention is also applicable to a monomorph type beam.

The region at one end of the substrate 10 that is not covered with the piezoelectric elements 20 is covered with a supporting portion 30 except for an end of the first terminal 11. That is, the beam 25 is supported by the supporting portion 30 in a cantilever manner. The supporting portion 30 has a thin rectangular shape. The supporting portion 30 has a front surface (an upper surface in FIGS. 1B and 2B) 30a and a back surface (a lower surface in FIGS. 1B and 2B) 30b. The front and back surfaces 30a and 30b are parallel to each other, substantially flat, and parallel to front and back surfaces of the beam 25. Welding protrusions (energy directors), which are used for joining the supporting portions 30 to each other by ultrasonic welding as described below, may be formed on at least one of the front surface 30a and the back surface 30b of the supporting portion 30. The welding protrusions serve to join joint surfaces to each other, because resins in contact with each other are partially melted due to frictional heat when ultrasonic welding is performed. As illustrated in FIG. 2B, the thickness of the supporting portion 30 is several times the thickness of the substrate 10. One end of the substrate 10 is embedded in the middle of the supporting portion 30 in the thickness direction and fixed to the supporting portion 30. The first terminal 11 extends through the supporting portion 30, and one end of the first terminal 11 is exposed from the supporting portion 30.

As illustrated in FIGS. 2A and 2B, a second terminal 12 is embedded in the supporting portion 30 at a position adjacent to the first terminal 11. The second terminal 12 is made of the same material as the substrate 10. The second terminal 12 is separated from the substrate 10 and the first terminal 11, and the body of the supporting portion 30 existing therebetween prevents a short-circuit. As with the first terminal 11, the second terminal 12 is exposed from the supporting portion 30. Thus, a pair of ends of the first terminal 11 and the second terminal 12 are exposed from an end of the supporting portion 30. Core wires at ends of lead wires 41 for feeding electricity are respectively connected, with pieces of solder 42, to front surfaces of exposed end portions 11a and 12a of the terminals 11 and 12.

The supporting portion 30 is made by molding a resin. In particular, insert molding, which can mold the supporting portion 30 and at the same time integrate the substrate 10 and the second terminal 12, is suitably used. In this case, insert molding is performed by arranging an end portion of the substrate 10 adjacent to the first terminal 11 and the second terminal 12 in a die, subjecting the arrangement to molding with a melted resin injected into the die, and then curing the resin.

As illustrated in FIG. 2A, the second terminal 12 is a thin metal plate that is substantially L-shaped. The second terminal 12 includes a long-plate portion 12b, which is on the exposed end portion 12a side, and a short-plate portion 12c. A pin insertion hole 12d is formed at the intersection of the long-plate portion 12b and the short-plate portion 12c. As illustrated in FIGS. 2A and 2B, a circular hole 31 is formed in the front surface 30a of the supporting portion 30. Through the circular hole 31, the pin insertion hole 12d and a part of the second terminal 12 surrounding the pin insertion hole 12d are exposed. As illustrated in FIGS. 1C and 2B, a recess 32 is formed in the back surface 30b of the supporting portion. Through the recess 32, the pin insertion hole 12d and a part of the second terminal 12 surrounding the pin insertion hole 12d are exposed. The recess 32 is U-shaped and open through a side surface of the supporting portion 30.

Linear grooves (conductive-member-containing recesses) 33 and 34, which extend from the hole 31 and the recess 32 to end surfaces of a distal end portion (an end portion on the beam 25 side) of the supporting portion 30, are respectively formed in the front surface 30a and the back surface 30b of the supporting portion 30. The grooves 33 and 34 have the same depth, and extend from the pin insertion hole 12d in the longitudinal direction of the beam 25.

A pin (conductive member) 50 is inserted through the pin insertion hole 12d in the second terminal 12. The pin 50 is made by bending an elastic metal bar. As illustrated in FIG. 2B, the pin 50 is U-shaped, and has long bar portions 52 on both sides of a short middle portion 51. The middle portion 51 of the pin 50 is inserted through the pin insertion hole 12d in the second terminal 12, and the long bar portions 52 of the pin 50 are fitted into and contained in the grooves 33 and 34.

The long bar portions 52 of the pin 50 elastically contact the bottom portions of the grooves 33 and 34, so that the body of the supporting portion 30 between the groove 33 and the groove 34 is clamped between the long bar portions 52. The pin 50 has a thickness that is sufficiently smaller than the depth of the grooves 33 and 34. Therefore, the long bar portions 52 do not protrude from the front surface 30a and the back surface 30b of the supporting portion 30, and are embedded and contained in the grooves 33 and 34. The long bar portions 52 extend to electrodes (not shown) of the piezoelectric elements 20. End portions 52a are connected to the electrodes with pieces of solder (electrically conductive adhesive) 43, which are conductive joint members. The electrodes are formed by a conductive material, such as a silver paste, over substantially the entire areas of the front and back surfaces of the piezoelectric elements 20. The electrode need not be formed on surfaces of the piezoelectric elements 20 facing the substrate 10, because electrical connection is provided by the substrate 10 over the entire areas of such surfaces of the piezoelectric elements 20 even without the electrodes. A part of the pin 50 that is exposed in the recess 32 on the back surface 30b side of the supporting portion 30 is connected to the second terminal 12 with a piece of solder 44.

As illustrated in FIGS. 2A and 2C, first conductive holes (hollow spaces) 35 are respectively formed in the front surface 30a and the back surface 30b of the supporting portion 30. The first conductive holes 35 are circular and extend to the end portion of the substrate 10 embedded in the supporting portion 30. The first conductive holes 35 have the same size, and face each other with the substrate 10 therebetween. As illustrated in FIGS. 2A and 2B, second conductive holes (hollow spaces) 36 are respectively formed in the front surface 30a and the back surface 30b of the supporting portion 30. The second conductive holes 36 are circular and extend to the second terminal 12 embedded in the supporting portion 30. The second conductive holes 36 have the same size as the first conductive holes 35, and face each other with the second terminal 12 therebetween.

(1-2) Manufacturing Process

The manufacturing process of the exciter 1, which has the above structure, will be described.

FIG. 3A illustrates the substrate 10 supported by the supporting portion 30, which is made by insert molding or the like, and the piezoelectric elements 20. In the next step, as illustrated in FIG. 3B, the piezoelectric elements are affixed to both sides of the substrate 10 with an adhesive or the like. Next, the pin 50 is attached to the supporting portion 30. As illustrated in FIG. 3B, one of the long bar portions 52 of the pin 50 is inserted through the pin insertion hole 12d in the second terminal 12. As illustrated in FIG. 3C, the middle portion 51 is inserted through the pin insertion hole 12d while elastically bending the pin 50. Then, the pin 50 is rotated in a direction R, and the long bar portions 52 are fitted into the grooves 33 and 34.

As described above, the long bar portions 52 of the pin 50 elastically contact the bottom portions of the grooves 33 and 34, respectively. In this state, gaps are formed between the end portions 52a and the electrodes of the piezoelectric elements 20. The sizes of the gaps are determined in accordance with the depth of the grooves 33 and 34. In other words, the depth of the grooves 33 and 34 are set so that the gaps are formed between the end portions 52a and the electrodes of the piezoelectric elements 20. The sizes of the gaps are smaller than about 0.5 mm.

Thus, the pin 50 is attached to the supporting portion 30, the end portions 52a of the long bar portions 52 of the pin 50 are connected to the electrodes of the piezoelectric elements 20 with the pieces of solder 43, and the part of the pin 50 that is exposed in the recess 32 in the back surface 30b of the supporting portion 30 is connected to the second terminal 12 with the piece of solder 44. The core wires of the lead wires 41 are respectively connected to the exposed end portions 11a and 12a of the first terminal 11 and the second terminal 12 with the pieces of solder 42. As a result, the exciter 1 according to the present embodiment is produced (FIGS. 3D and 3E).

(1-3) Operation of Exciter

In the exciter 1 according to the present embodiment, an alternating signal, which is derived from an alternating voltage, is supplied to the substrate 10 of the beam 25, which is supported by the supporting portion 30, through the first terminal 11 and supplied to the piezoelectric elements 20 through the second terminal 12 and the pin 50. When the alternating signal is supplied, the piezoelectric elements extend and contract in the longitudinal direction, and the entirety of the beam 25 warps and vibrates. The beam 25 vibrates at a frequency corresponding to the supplied alternating signal. The exciter 1 is used by affixing the front surface 30a or the back surface 30b of the supporting portion 30 to a flat surface of, for example, a liquid crystal panel, so that the exciter 1 vibrates the panel to generate a sound. The exciter 1 may be affixed to an apparatus with an adhesive, a double-sided adhesive tape, or the like.

(1-4) Operational Advantages of Exciter

In the exciter 1, the pin 50, which is attached to the supporting portion 30 so as to connect the second terminal to the electrodes of the piezoelectric elements 20, is contained in the grooves 33 and 34, which are formed in the supporting portion 30, in an embedded state. Therefore, the pin 50 does not protrude from the front surface 30a and the back surface 30b of the supporting portion 30, so that the front surface 30a and the back surface 30b are flat. At least one of the front surface 30a and the back surface 30b is attached to the apparatus, and a large attachment surface is provided without being interfered by the pin 50. As a result, the exciter 1 can be fixed to the apparatus with sufficient strength, whereby the performance of the exciter 1 can be fully utilized.

As described above, in the exciter 1 according to the present embodiment, the supporting portion 30 made of a resin is insert molded together with the substrate 10. After the insert molding, the piezoelectric elements 20 are affixed to the substrate 10 to form the beam 25. This method is preferable for the following reasons. That is, molding of the supporting portion 30 and integration of the supporting portion 30 and the substrate 10 can be performed with one step, so that productivity is improved and the substrate 10 can be strongly fixed to the supporting portion 30. Moreover, the supporting portion 30 can be positioned relative to the substrate 10 with a higher precision.

Furthermore, insert molding can be performed without considering an influence of heat to the piezoelectric elements 20, because, the piezoelectric elements 20 has not been affixed to the substrate 10 before the resin is heated and melted in the insert molding process. Therefore, the resin used as a material of the supporting portion 30 is not limited to a low-temperature type, and flexibility in the choice of the resin material is increased. For example, the cost can be reduced by using an inexpensive resin. By molding a thin member using a high-mobility material, the size and the thickness of the exciter can be reduced.

In the present embodiment, the pin 50, which is elastic and U-shaped, is used as a conductive member of the present invention. Because the pin 50 is thin and occupies a comparatively small space, the grooves 33 and 34 that contain the pin 50 can be made small accordingly. Therefore, reduction in the areas of the front surface 30a and the back surface 30b of the supporting portion 30 is suppressed, and the strength of fixing can be increased also in this respect.

### [2] Stacked Exciter

Next, a piezoelectric exciter unit according to the present invention will be described.

(2-1) Structure

FIGS. 4A-4D illustrate an exciter unit according to an embodiment. The exciter unit 2 is a stacked exciter including two single exciters 1, each according to the above embodiment.

The two exciters 1 are joined to each other so that the back surface 30b of the supporting portion 30 of one of the exciters 1 is superposed on the front surface 30a of the supporting portion 30 of the other of the exciters 1 and so that the beams 25 extend in the same direction. The supporting portion 30 can be joined to each other by using an adhesive or a double-sided adhesive tape. However, ultrasonic welding is preferably used, because of high strength of fixing and high productivity.

The beams 25 are disposed parallel to each other. A rectangular cushioning member 60 is interposed between the beams 25 in order to maintain a distance between the beams 25 and prevent the beams 25 from contacting each other. The cushioning member 60 is preferably made of an elastic member that is electrically insulating and flexible, such as a rubber or a urethane. The cushioning member 60 is affixed to one or both of the beams 25 by adhesion or other means. The lead wires 41 are not connected to one of the exciters (in this case, the upper one in FIG. 4B) 1, and are connected only to the lower exciter 1.

As illustrated in FIG. 5C, the first conductive hole 35 formed in the back surface 30b of the supporting portion 30 of the upper exciter 1 is continuous with the first conductive hole 35 formed in the front surface 30a of the supporting portion 30 of the lower exciter 1. In the first conductive holes 35, which are continuous with each other, a metal coil spring (terminal conductive member, elastic member) 55 is in contact with and interposed between the upper and lower substrates 10 in a compressed state. Likewise, the second conductive hole 36 formed in the back surface 30b of the supporting portion 30 of the upper exciter 1 is continuous with the second conductive hole 36 formed in the front surface 30a of the supporting portion 30 of the lower exciter 1. In the second conductive holes 36, which are continuous with each other, another metal coil spring (terminal conductive member, elastic member) 55 is in contact with and interposed between the upper and lower second terminals 12 in a compressed state (see FIG. 5B).

(2-2) Manufacturing Process

The manufacturing process of the exciter unit 2, which has the structure described above, will be described. FIG. 6A illustrates the exciter unit 2, which is disassembled into two exciters 1, the cushioning member 60, and the coil springs 55. In the next step, as illustrated in FIG. 6B, the coil springs 55 are fitted into the conductive holes 35 and 36 in the supporting portion 30 of the lower exciter 1. The cushioning member 60 is affixed to the beam 25 of the lower exciter 1.

Next, the supporting portion 30 of the upper exciter 1 is superposed on the supporting portion 30 of the lower exciter 1, and the coil springs 55 are fitted into the conductive holes 35 and 36 of the upper supporting portion 30. Then, the supporting portions 30 are joined to each other by ultrasonic welding or other means as described above. Thus, the exciter unit 2 according to the present embodiment is produced (see FIGS. 6C and 6D).

(2-3) Operation of Exciter Unit

In the exciter unit 2 according to the present embodiment, an alternating signal is supplied to the upper and lower exciters 1 through the lead wires 41 connected to the lower exciter 1. That is, the alternating signal that is supplied to the first terminal 11 of the lower exciter 1 is supplied not only to the substrate 10 of the lower exciter 1 but also to the substrate 10 of the upper exciter through the coil spring 55 that is in contact with the first terminal 11. On the other hand, the alternating signal that is supplied to the second terminal 12 of the lower exciter 1 is supplied from the second terminal 12 not only to the piezoelectric elements 20 through the pin 50 but also to the piezoelectric elements 20 of the upper exciter 1 through the coil spring 55 that is in contact with the second terminal 12. Thus, the upper and lower beams 25 vibrate.

(2-4) Operational Effect of Exciter Unit

The exciter unit 2 is made by stacking the supporting portions 30 of the single exciters 1. In each of the exciters 1, the pin 50 is contained in the grooves 33 and 34 in an embedded state, and does not protrude from the front surface 30a and the back surface 30b. Therefore, the exciters 1 can be joined to each other so that the supporting portions 30 closely contact each other. As a result, the exciters 1 can be joined to each other with sufficient strength.

Because the exciter unit 2 is made by stacking the individual exciters 1, each of which has been completed, when there are various needs for functions, the needs can be easily fulfilled by combining the exciters having different characteristics. Therefore, time and effort needed to produce the exciter unit 2 are reduced, the efficiency of the production line can be increased, the product can be standardized, and the cost can be reduced.

Because the first terminals 11 and the second terminals 12 of the two exciters 1 are respectively connected to each other with the coil springs 55, electricity can be fed to the two exciters 1 by feeding the electricity to one of the exciters 1 (the lower one in the figures). Therefore, the lead wires 41 for feeding electricity may be connected to only one of the exciters 1, whereby the structure can be simplified. Because the coil springs 55 are interposed between the terminals (between the first terminals 11 and between the second terminals 12) and do not protrude to the outside, the thickness can be reduced. Because the coil springs 55 are interposed between the terminals in a compressed state, electrical connection between the terminals are secure and stable.

In the present embodiment, a coil spring is used as a terminal conductive member that is interposed between terminals. In such a case, by using a coil spring having a conical shape instead of a general constant-diameter coil spring, the thickness of the coil spring in a compressed state is reduced, whereby the thickness of the exciter can be effectively reduced.

As a terminal conductive member that connects terminals to each other, a member other than a coil spring can be used as long as the member is an elastic member that can be interposed between the terminals in an elastically deformed state. By using such an elastic member, electrical connection between terminals can be made secure and stable. Although two exciters are stacked in the exciter unit, the number of stacked exciters may be arbitrarily determined in accordance with the needs.

### BRIEF DESCRIPTION OF DRAWINGS

FIGS. 1A-1D illustrate a single exciter according to an embodiment of the present invention, in which FIG. 1A is a plan view, FIG. 1B is a side view, FIG. 1C is a rear view, and FIG. 1D is an end view from a beam side.

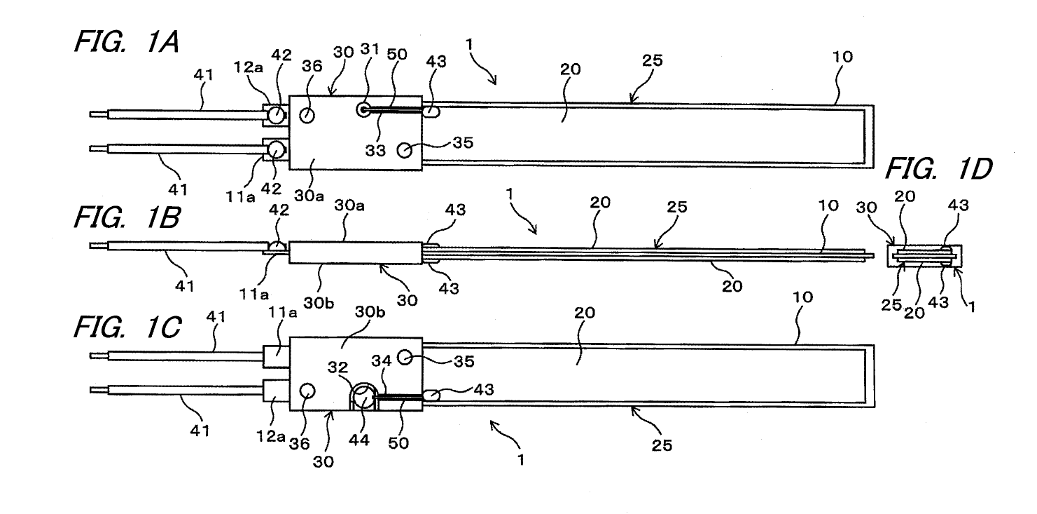

FIGS. 2A-2C illustrates the single exciter, in which FIG. 2A is a partial plan view, FIG. 2B is a sectional view taken along line II-II of FIG. 2A, and FIG. 2C is a sectional view taken along line II′-II′ of FIG. 2A.

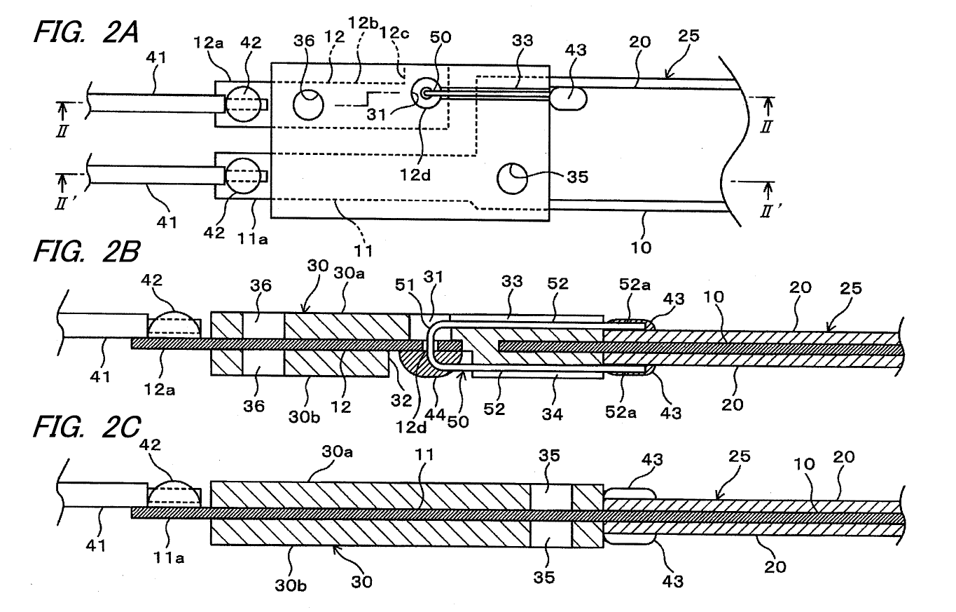

FIGS. 3A-3E are perspective views illustrating the manufacturing process of the single exciter.

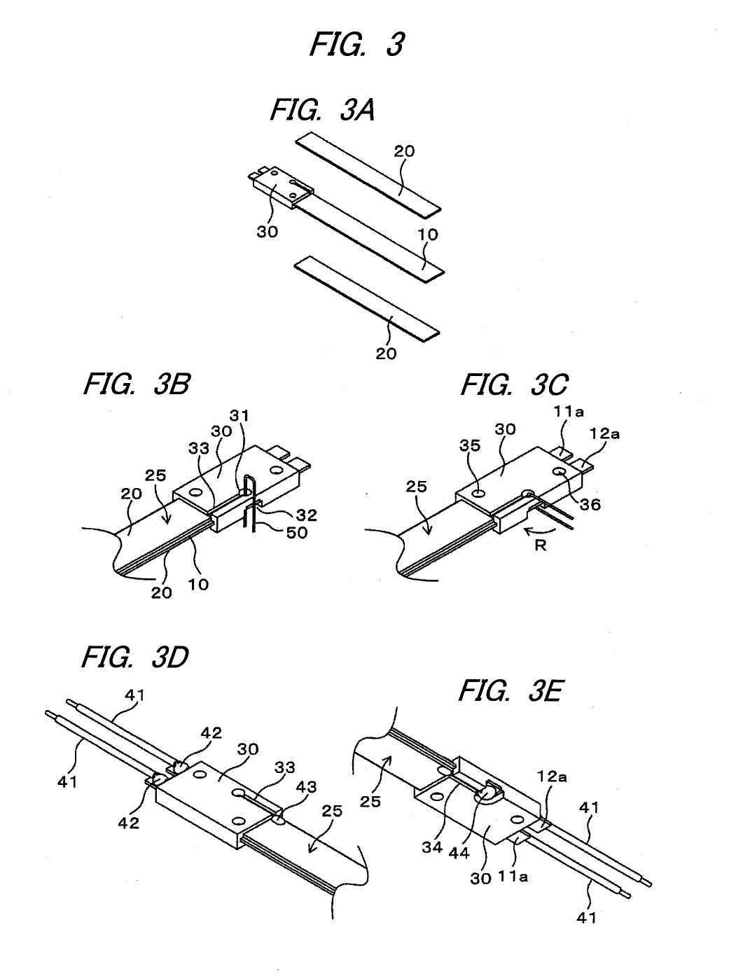

FIGS. 4A-4D illustrate a stacked exciter according to an embodiment of the present invention, in which FIG. 4A is a plan view, FIG. 4B is a side view, FIG. 4C is a rear view, and FIG. 4D is an end view from a beam 25 side.

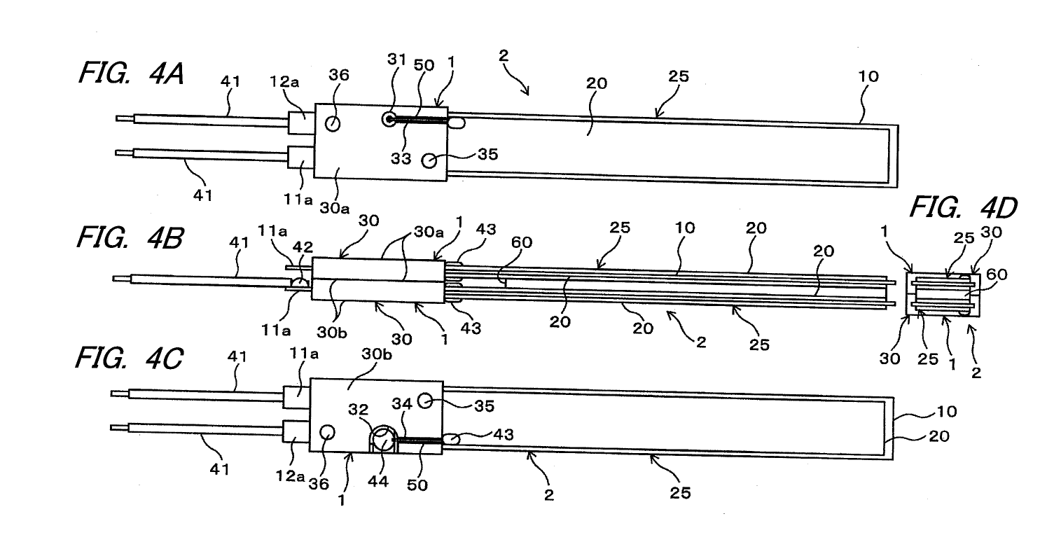

FIGS. 5A-5C illustrate the stacked exciter, in which FIG. 5A is a partial plan view, FIG. 5B is a sectional view taken along line V-V of FIG. 5A, and FIG. 5C is a sectional view taken along line V′-V′ of FIG. 5A.

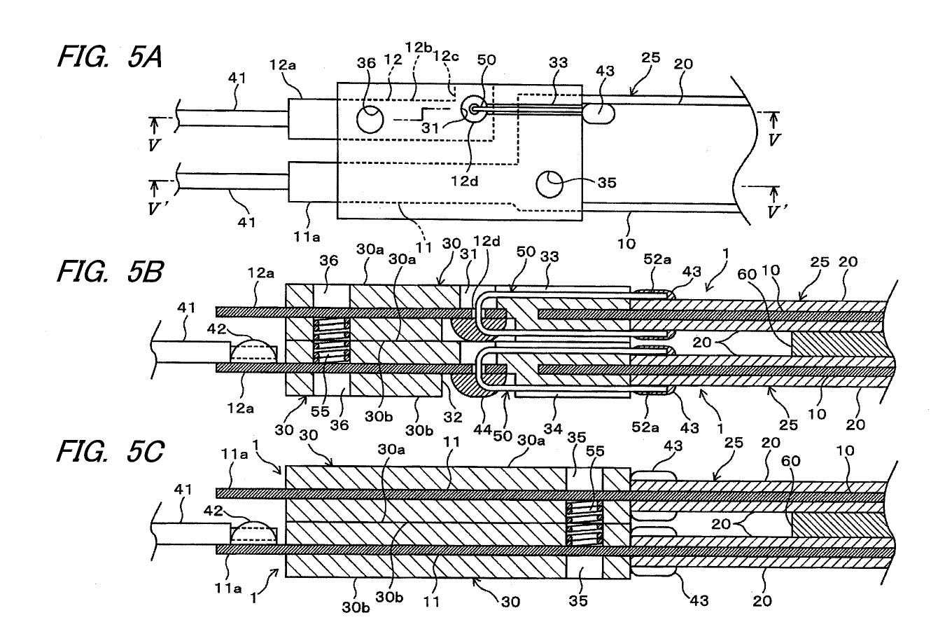

FIGS. 6A-6D are perspective views illustrating the manufacturing process of the stacked exciter.

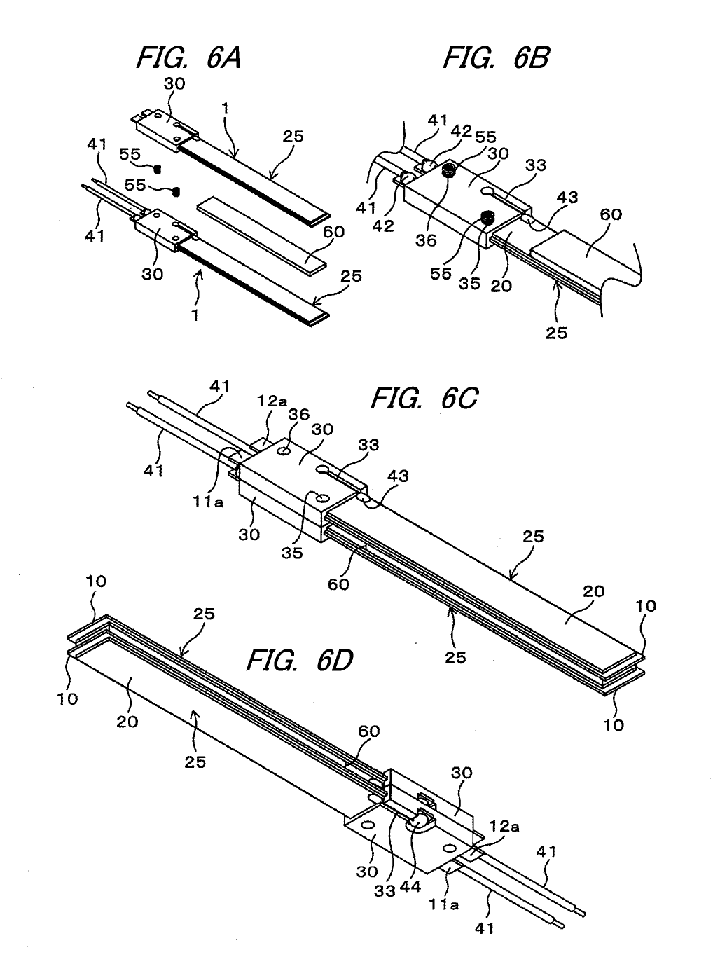

### REFERENCE SIGNS LIST

1 exciter
2 exciter unit
10 substrate
11 first terminal
12 second terminal
20 piezoelectric element
25 beam
30 supporting portion
33, 34 groove (conductive-member-containing recess)
35, 36 hole (hollow space)
43 piece of solder (conductive joint member)
50 pin (conductive member)
55 coil spring (terminal conductive member, elastic member)

1. (canceled)

2. (canceled)

3. (canceled)

4. (canceled)

5. (canceled)

6. (canceled)

7. (canceled)

8. (canceled)

9. A piezoelectric exciter comprising: a beam including a substrate and a piezoelectric element affixed to the substrate; a supporting portion that supports the beam; a terminal fixed to the supporting portion, the terminal feeding electricity to the piezoelectric element; and a conductive member that electrically connects the terminal to an electrode of the piezoelectric element, wherein a conductive-member-containing recess is formed in the supporting portion and the conductive member is contained in the conductive-member-containing recess in an embedded state and wherein the supporting portion is made of a resin that is subjected to insert molding together with the substrate and the beam is made by affixing the piezoelectric element to the substrate after the insert molding.

10. The piezoelectric exciter according to claim 9, wherein the terminal comprises a first terminal integrally formed with the substrate at an end of the substrate on the supporting portion side and a second terminal provided adjacent to the first terminal, the first terminal and the second terminal are separately embedded in the supporting portion, an insertion hole is formed on the second terminal, a hole and a recess, through which the insertion hole is exposed, are respectively formed on the front surface and the back surface of the supporting portion, and the conductive-member-containing recess comprises a groove extending from the hole or the recess to the end surface of the supporting portion on the beam side.

11. The piezoelectric exciter according to claim 9, wherein the conductive member is an elastic pin, and the pin is contained in the conductive-member-containing recess in a state in which the pin elastically contacts a bottom portion of the conductive-member-containing recess.

12. The piezoelectric exciter according to claim 10, wherein the conductive member is an elastic pin, and the pin is contained in the conductive-member-containing recess in a state in which the pin elastically contacts a bottom portion of the conductive-member-containing recess.

13. The piezoelectric exciter according to claim 9, wherein the depth of the conductive-member-containing recess is set so that a gap is generated between the conductive member and the electrode of the piezoelectric element when the conductive member 29 is contained in the conductive-member-containing recess, and the conductive member and the electrode are connected to each other with a conductive joint member.

14. The piezoelectric exciter according to claim 10, wherein the depth of the conductive-member-containing recess is set so that a gap is generated between the conductive member and the electrode of the piezoelectric element when the conductive member is contained in the conductive-member-containing recess, and the conductive member and the electrode are connected to each other with a conductive joint member.

15. The piezoelectric exciter according to claim 11, wherein the depth of the conductive-member-containing recess is set so that a gap is generated between the conductive member and the electrode of the piezoelectric element when the conductive member is contained in the conductive-member-containing recess, and the conductive member and the electrode are connected to each other with a conductive joint member.

16. The piezoelectric exciter according to claim 12, wherein the depth of the conductive-member-containing recess is set so that a gap is generated between the conductive member and the electrode of the piezoelectric element when the conductive member is contained in the conductive-member-containing recess, and the conductive member and the electrode are connected to each other with a conductive joint member.

17. A piezoelectric exciter unit comprising a plurality of the piezoelectric exciters each according to claim 9, the piezoelectric exciters being stacked so that the supporting portions thereof are superposed on each other and joined to each other, wherein a hollow space is formed in the supporting portion of each of the piezoelectric exciters, the hollow space extending, in a stacked state, from the terminal of the piezoelectric exciter to the terminal of the other one of the piezoelectric exciters that is stacked on the piezoelectric exciter, and wherein a terminal conductive member is interposed between the terminals in the hollow spaces that are continuous with each other, the terminal conductive member electrically connecting the terminals to each other.

18. A piezoelectric exciter unit comprising a plurality of the piezoelectric exciters each according claim 10, the piezoelectric exciters being stacked so that the supporting portions thereof are superposed on each other and joined to each other, wherein a hollow space is formed in the supporting portion of each of the piezoelectric exciters, the hollow space extending, in a stacked state, from the terminal of the piezoelectric exciter to the terminal of the other one of the piezoelectric exciters that is stacked on the piezoelectric exciter, and wherein a terminal conductive member is interposed between the terminals in the hollow spaces that are continuous with each other, the terminal conductive member electrically connecting the terminals to each other.

19. A piezoelectric exciter unit comprising a plurality of the piezoelectric exciters each according claim 11, the piezoelectric exciters being stacked so that the supporting portions thereof are superposed on each other and joined to each other, wherein a hollow space is formed in the supporting portion of each of the piezoelectric exciters, the hollow space extending, in a stacked state, from the terminal of the piezoelectric exciter to the terminal of the other one of the piezoelectric exciters that is stacked on the piezoelectric exciter, and wherein a terminal conductive member is interposed between the terminals in the hollow spaces that are continuous with each other, the terminal conductive member electrically connecting the terminals to each other.

20. The piezoelectric exciter unit according to claim 17, wherein the terminal conductive member is an elastic member that elastically contacts the terminals.

21. The piezoelectric exciter unit according to claim 18, wherein the terminal conductive member is an elastic member that elastically contacts the terminals.

22. The piezoelectric exciter unit according to claim 19, wherein the terminal conductive member is an elastic member that elastically contacts the terminals.

23. The piezoelectric exciter unit according to claim 17, wherein a cushioning member is interposed between the beams of the piezoelectric exciters.

24. The piezoelectric exciter unit according to claim 18, wherein a cushioning member is interposed between the beams of the piezoelectric exciters.

25. The piezoelectric exciter unit according to claim 19, wherein a cushioning member is interposed between the beams of the piezoelectric exciters.

26. The piezoelectric exciter unit according to claim 17, wherein the supporting portions are joined to each other by ultrasonic welding.

27. The piezoelectric exciter unit according to claim 18, wherein the supporting portions are joined to each other by ultrasonic welding.

28. The piezoelectric exciter unit according to claim 19, wherein the supporting portions are joined to each other by ultrasonic welding.

29. The piezoelectric exciter unit according to claim 19, wherein the terminal conductive member is an elastic member that elastically contacts the terminals, and a cushioning member is interposed between the beams of the piezoelectric exciters.

30. The piezoelectric exciter unit according to claim 29, wherein the supporting portions are joined to each other by ultrasonic welding.
